(19) United States
(12) Patent Application Publication
(10) Pub. No.: US 2024/0202357 A1
(43) Pub. Date: Jun. 20, 2024

(54) Differentially Private Synthetic Data

(71) Applicant: Oracle International Corporation, Redwood City, CA (US)

(72) Inventor: Daniel Wyde Peterson, Laramie, WY (US)

(21) Appl. No.: 18/066,939

(22) Filed: Dec. 15, 2022

(51) Int. Cl. G06F 21/62

(52) U.S. Cl. CPC G06F 21/6245

(57) ABSTRACT

Methods, techniques and systems are described for limiting privacy loss in machine learning systems. A machine learning system may produce a generative model through machine learning training using a real data set that includes information identifying one or more sources and differential privacy guarantees for data in the real data set are not ensured. The generative model may therefore model data including identifiable data for particular individuals or sources contributing to the real data set. An estimate of training sensitivity for the training of the generative model with respect to the real data set may then be made, then the machine learning system may generate a synthetic data set according to sampling of the trained generative model, where the sampling is determined by the estimate of training sensitivity and a desired level of privacy guarantee to ensure differential privacy of the data in the real data set.

### BACKGROUND

### Field of the Disclosure

This disclosure relates to an improved method for providing differential privacy for data sets in machine learning systems.

### Description of the Related Art

Security and privacy are often concerns in machine learning systems which may grant wide access to raw data, especially data about individuals, thus posing many potential dangers to the data owners and subjects Differential privacy is a tool that bounds the risk of releasing individual records and is gaining widespread acceptance as a defense mechanism in machine learning. Enforcing differential privacy guarantees traditionally requires training a machine learning system under differential privacy constraints. In theory, this allows the system to be used to generate any amount of data with no further privacy loss. This approach, however, may severely degrade the utility of the trained model.

### SUMMARY

Methods, techniques and systems are described for limiting privacy loss in machine learning systems. A machine learning system may produce a generative model through machine learning training using a real data set, where the real data set includes information identifying one or more sources and differential privacy guarantees for data in the real data set are not ensured. The generative model may model data including identifiable data for particular individuals or sources contributing to the real data set. An estimate of training sensitivity for the training of the generative model with respect to the real data set may then be made, then the machine learning system may generate a synthetic data set according to sampling of the trained generative model, where the sampling is determined by the estimate of training sensitivity and a desired level of privacy guarantee to ensure differential privacy of the data in the real data set.

### BRIEF DESCRIPTION OF THE DRAWINGS

FIG. 1 is a block diagram illustrating a system providing differentially private synthetic data in various embodiments.

FIG. 2 is a flowchart illustrating an embodiment for producing differentially private synthetic data.

FIG. 3 is a flowchart illustrating an embodiment for estimating privacy costs for generating samples synthetic data using a generative model.

FIG. 4 is a flowchart illustrating an embodiment for generating samples of synthetic data using a generative model.

FIG. 5 is a block diagram illustrating one embodiment of a computing system that is configured to implement position-independent addressing modes, as described herein.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Security and privacy are often concerns in machine learning systems which may grant wide access to raw data, especially data about individuals, thus posing many potential dangers to the data owners and subjects. Machine learning from that data, however, has the power to improve lives. Differential privacy is a tool that bounds the risk of releasing individual records and is gaining widespread acceptance as a defense mechanism in machine learning.

Differential privacy provides a mathematical mechanism to address a part of this issue. Essentially, a differentially private system outputs a sample from a distribution through a random mechanism and provides a toolkit to guarantee that the distribution is nearly identical whether any individual data sample is in the data set or not. This minimizes the harm to any individual sample in the data set because it is difficult to confidently identify the underlying distribution from a single sample.

In the current state of the art, enforcing differential privacy guarantees requires training a machine learning system under differential privacy constraints. In theory, this may allow the system to be used to generate increasing amounts of data without increasing privacy loss. This approach, however, may severely degrade the utility of the trained model.

In real-world data sets, it is not necessarily known in advance what questions may be required. Therefore, an amount of randomness cannot be known up-front. If more randomness is used than necessary, the utility of the data may be harmed; however if less randomness is used than required, privacy of the individuals in the data set may be harmed as successive queries may reduce ambiguity. For example, imagine asking the number of women in leadership roles from a job statistics data set. If the question is asked once a single sample from a distribution is obtained and none of the individual women are likely to be identified. If the same question is asked multiple times, or in multiple ways, say by querying number of women, number of women in non-leadership roles, number of men, number of men in leadership roles, and number of people in leadership roles, the uncertainty about the real answer may be reduced and the privacy protection similarly reduced. Giving differentially private access to the underlying database is, therefore, a non-trivial task.

Generating synthetic data is therefore an attractive method to allow release of data sets that may otherwise be too sensitive. Under this approach, a data owner first trains a generative model on the real data without consideration for privacy of data sources. The data owner may then use the generative model to produce and release a synthetic data set from a similar underlying distribution.

The generated synthetic data set may be safer to use and distribute as the data may not correspond to real world users making it nearly impossible to connect records one-to-one with real-world counterparts. As no techniques to protect privacy are employed in the creation of the generative model, the generative model should have the highest utility possible while avoiding a release of the underlying true data records of the real data set. However, even synthetic data may leak critical details about the training data points if privacy is not correctly accounted for. Therefore, influence functions may then be employed to determine a privacy cost associated with generating a synthetic sample from the generative model the estimated privacy cost usable to constrain the total privacy loss incurred in the generation of a synthetic data set.

In contrast, samples from a generative model trained with differential privacy may not capture enough of the correlations in the real data set to be as useful for downstream tasks. Furthermore, adding more data points may not improve system accuracy if the added data points do not adequately model reality. Over the course of training the generative model with differential privacy, gradients may be clipped and noise added to obscure the exactness of the gradient computations and, in doing so, provide privacy for data points contributing to the gradients. A generative model trained with differential privacy (DP) guarantees has the advantage that any data it generates will have the same DP guarantee: sampling from a private generator does not add privacy loss regardless of the amount of synthetic data generated.

A major downside, however, is that complex models, such as data generators, are difficult to train under DP guarantees without access to massive data sets, and performance of the models may degrade when trained with differential privacy. This means a private generator will likely generate low-fidelity, poorly-representative data, and even an infinite amount of bad data is unlikely to aid machine learning efforts. Also, in practice, all generated data sets will be finite, limited by the computational resources devoted to training, storing, and distributing the synthetic data set.

Generative models may instead be trained without DP guarantees of any kind, with privacy loss bounded in the sampling step where synthetic data is generated. A key insight is that an attacker with access only to the generated synthetic data set will be stymied in tying anomalies to the real world, so long as the generation process would be nearly the same whether any particular individual were part of the real data.

Training the generator with DP guarantees means that the training process of the generator could arrive at the same model with or without any data point. Instead, a method for estimating the privacy cost of generating a single synthetic data sample is employed and a privacy budget is used while generating a finite number of samples from the trained data generator. Models trained on a small sample of accurate synthetic data are, in practice, likely to be more accurate than models trained on a large amount of inaccurate synthetic data. This improved process may provide synthetic data sets under differential privacy guarantees more effectively than the current state of the art.

Several methods of generating synthetic data that are known, including Generative Adversarial Networks (GANs), neural normalizing flows (flows) and Variational Autoencoders (VAEs). These are mathematically and philosophically distinct.

### Generative Adversarial Networks (GANs)

Generative Adversarial Networks (GANs) are a popular method for training synthetic data generators. They are called “Adversarial” because training a GAN involves training two networks: one that generates appropriate-dimensioned data using a neural network (hereafter, the generator network), and one that learns to distinguish between real data and fake data (hereafter, the discriminator). Both networks are trained together: first the generator creates a batch of fake data, and this fake data is sent alongside a batch of real data to the discriminator. The discriminator is updated with the objective of identifying which data is real and which is not real. As long as the discriminator network can tell the difference between real and fake data, the generator has more to learn. The discriminator then feeds this information back to the generator including information regarding how fake data can be identified. The generator learns to hide the identifying information and generates a new batch of data. Training of both networks may occur in a loop such that as the generator gets more sophisticated in its creation of fake data, the discriminator gets more refined at spotting weaknesses. The training is said to have converged when the discriminator is no longer able discriminate between real and fake samples.

GANs are popular because they can generate extremely realistic fake data. Training two networks together is delicate and may fail based on random initialization; this problem is mitigated by work such as Wasserstein GANs (WGANs) and gradient penalties (WGAN-GP and WGAN-LP). GAN training also is prone to an issue called “mode collapse,” where statistical regularities that affect only a minor part of the population are never represented in the data. For example, a generator that creates fake US Households for a census-like report. Only 3% of Americans have a doctoral degree, and these households may have a different distribution of attributes like income and family size. In early training rounds, if the discriminator identifies data as fake due to an education level of post-graduate degree, the generator will create fewer such examples and have a harder time learning these statistical differences. When training converges, the generator may seldom, if ever, generate households with post-graduate degrees: the discriminator is less likely to learn that data is fake, for example, there are not enough doctors, because that's inherently a harder problem. In this way, small (but potentially important) sections of the data may be entirely missing from a synthetic data set.

GANs may be trained with differential privacy guarantees. In this setting, the discriminator's learning signals are randomized to provide differential privacy; since only the discriminator has access to the real data, the DP-guarantee of the discriminator extends to the generator.

### Neural Flow Architectures

While GANs are trained to maximize the “realness” of the generated data, neural flow models are trained to directly maximize the likelihood of the data set under the generative model. Each step involves learning a data transformation that slowly builds from a simple base distribution (i.e. a spherical Gaussian) to the complex distribution of the observed data. Critically, each step of this transformation must be invertible because this implies there is a one-to-one map between the observed data point and the Gaussian distribution. Each transformation makes the data distribution look more like a spherical Gaussian; this progressive transformation of variables that reduces a complex distribution to a simple one is called a “flow”.

Autoregressive Flows (and their family, which includes Inverse Autoregressive Flows, and Masked Autoregressive Flows) build the complex distribution one variable at a time, with each new variable conditioned on the already-selected values. This means that the number of steps in the flow is exactly identical to the number of variables in the data. Masked Autoregressive Flows allow for batching the computation of either the likelihood step or the generation step depending on whether the architecture is for ordinary autoregressive flows or inverse autoregressive flows, but the other operation will still require a complete pass through of the flow, with one step for each variable.

Non-linear Independent Components Estimation (NICE) and follow up work RealNVP and Generative Flows (GLOW), in contrast, use an architecture that decouples the number of layers in the flow from the number of variables, because each step of the flow samples a block of the variables at once. At each step, the variables are divided into two blocks: one block of “fixed” variables, and one block of “adjusted” variables. Only the “adjusted” variables may change, but the changes may depend on the values of the variables in the “fixed” block. By alternating which blocks of variables are taken as fixed (and which are adjusted) at each step of the flow, it is possible to model highly complex dependencies among the variables in the data set. Both likelihood computation and data generation can be run in the same amount of time, which depends only on the number of flow steps, and the mathematical form of the transforms allows for the potential of significant memory savings during training.

GLOW is capable of generating realistic images, although they do not yet match the image fidelity of the state-of-the-art GAN data generators. However, their objective is likelihood-based, and so mode collapse is explicitly penalized. If 3% of households should have a member with a post-graduate degree, the flow model will be penalized if the generator would have a significantly different post-graduate degree statistic.

### Variational Autoencoders

VAEs are trained using an encoder/decoder architecture. Each data point is mapped through the encoder to a list of statistical parameters (e.g. a mean and variance matrix) in a latent space. Samples are generated from that latent space using the encoded parameters and these samples are fed through the decoder. The final loss is a term that combines the deviation of the statistical parameters from a reference distribution, and the dissimilarity of the decoded samples to the original data point. In this way, the same data point is used to train both the encoder and the decoder networks. The two components of the final loss represent the likelihood of the data under the generative model, and the fidelity of the reconstructed data from the generator. In this sense, a variational autoencoder tries to achieve both the objectives of a GAN and a flow architecture. However, the likelihood computation is not exact because the encoder is not a reversible architecture and the generative model is trained to exactly mirror the training data given minor perturbations in the latent space.

### Empirical Privacy Estimation

A trained generative model may produce data samples from a learned distribution through the training process, where the generator's distribution converges to be similar to the empirical distribution of the training data set. To generate a data point, a sample from a simple distribution, like the spherical Gaussian, may be transformed. This means that generating a synthetic data point is equivalent to sampling from a fixed distribution, G with range R, which is itself a function of the learning algorithm and a data set X. Sampling a data point from the learned distribution, S˜G(X) is then (ε, δ)-DP if for all S∈R:

$$P ( S ∼ G ( X ) ) \leq {e}^{ϵ} P ( S ∼ G ( Y ) ) + δ ,$$

for all neighboring data sets Y who diff from X in a single data point. In strict ε-DP, δ=0, and the inequality must hold for all S, for all neighboring data sets X and Y. This inequality will hold trivially for some ε, as long as P (S˜G(X))>0 for all S∈R and for all X, but we want to control ε as a measure of privacy.

The sensitivity of the training process of the generator is not known in advance but may be measured empirically. This requires two components: first influence functions to measure the impact of the individual training points on the learned distribution G for the data set X. This impact is the local sensitivity of the training process on the given data set. Second, multiple estimates of this sensitivity on separate partitions of data may be used to estimate a smooth sensitivity of G in the neighborhood of the data set X. This may be used to calculate an approximate (ε, δ)-DP guarantee for sampling a data point from the generator.

Influence functions may enable estimates of how the model parameters would change if a particular data point were up-weighted or down-weighted. For example, an estimate of how the learned generator parameters \hat{θ} would change were one of N data points be removed, x, may be computed as:

$${\hat{θ}}_{- x} - \hat{θ} = ( 1 / N ) {H}_{\hat{θ}}^{- 1} {∇}_{θ} L ( x , \hat{θ} ) ,$$

where ∇_{θ}L(x, \hat{θ}) is the gradient loss function of the generator evaluated on point x and H⁻¹ is the Hessian of loss function on the full data set X. The most computationally intensive part of this computation is the Hessian computation, but in practice only a computation of a Hessian vector product may be needed, and not the full Hessian.

This calculation is a first-order approximation of the amount that parameters would change if a data point were removed from the training set. To see how that influences P (S˜G_{θ}(X)), the chain rule may be applied provided that the probability is simple to calculate.

Ideally, a worst-case scenario of data points x to add or remove from X may be used to compute the probability difference, and the worst-case S˜G_{θ}(X)). The heuristic S=x may be assumed when calculating the worst-case sensitivity. Given measured sensitivity for each of K data points independently and identically sampled from a distribution over data points in the range of the generator, R, the probability that a data point in that distribution would have an influence larger than the worst-case measured influence is δ=1. If these data points may be sampled uniformly from R, the ε calculated from the K data points provides a measured (ε, 1/K)-DP guarantee for data sets adjacent to X. If data points cannot be sampled uniformly from R, the data points may at least be sampled uniformly from X providing an interpretation of a guarantee that is closer to Bayesian Differential Privacy.

The computed local sensitivity around the data set X cannot be used for a global (ε, δ) guarantee as it is so closely tied to the data set; knowledge of the exact ε may reveal additional information about X, compromising privacy. But, by leveraging how much ε changes as new data points are added to X, an estimate of the smooth sensitivity εₛ in the region surrounding X may be obtained. Given a fixed privacy budget (ε_{b}, δ>0), N=|ϵ_{b}/εₛ| samples may be generated from the trained generator.

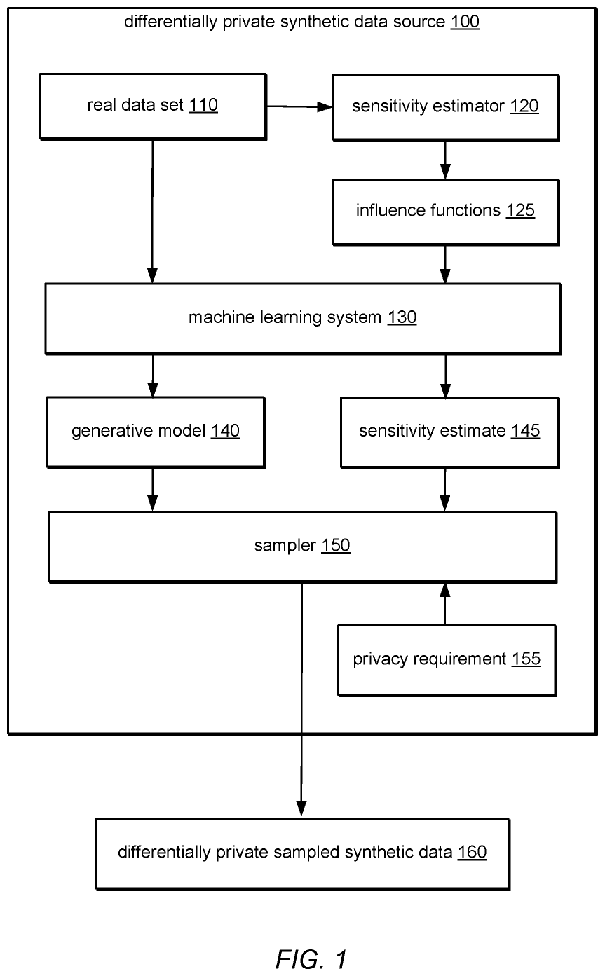

FIG. 1 is a block diagram illustrating a system providing differentially private synthetic data in various embodiments. A differentially private synthetic data source 100 may include a real data set 110 that may be input to a machine learning system 130, both directly and in the form of influence functions 125 derived from the real data set by a sensitivity estimator 120. The real data set may include information identifying one or more sources of the data and, therefore, differential privacy guarantees for data of the real data set are not ensured.

The machine learning system 120 may use the real data set, including the private information, to train a generative model 140 without ensuring privacy of data in the real data 110. Additionally, the sensitivity estimator 120 may provide the influence functions 125 to the machine learning system 125 to generate a sensitivity estimate 145, where the sensitivity estimate 145 comprises an estimation of the privacy cost of generating synthetic data samples using the generative model 140.

The resulting generative model 140 may then be sampled by sampler 150 to generate synthetic data 160. This sampling may be performed according to a provided or specified privacy requirement 155 along with the sensitivity estimate 145 to generate a maximum number of sampled data points in the synthetic data set 160. Samples of the synthetic data set 160 may not include data from the real data set 110 or information identifying private features of the real data set 110 that may correlate features of the synthetic data to features of the real data set is not included in the synthetic data 160.

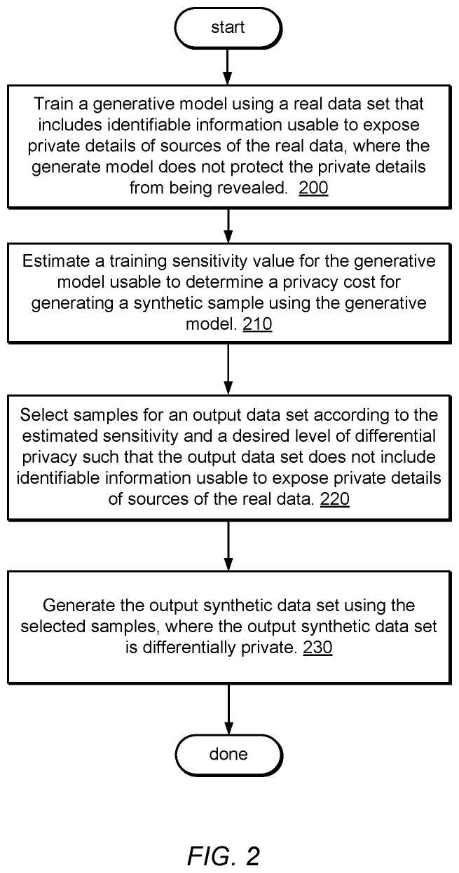

FIG. 2 is a flowchart illustrating an embodiment for producing differentially private synthetic data. The process begins at step 200 where a generative model, such as the generative model 140 of FIG. 1, may be trained using a machine learning system, such as the machine learning system 130 of FIG. 1, using a real data set such as the real data set 110 as shown in FIG. 1, in some embodiments. This training may be performed without privacy guarantees for the real data and the generated model may contain information usable to identify sources of data of the real data set. Therefore, privacy of data in the real data set is not ensured during the training or subsequent usage of the generative model.

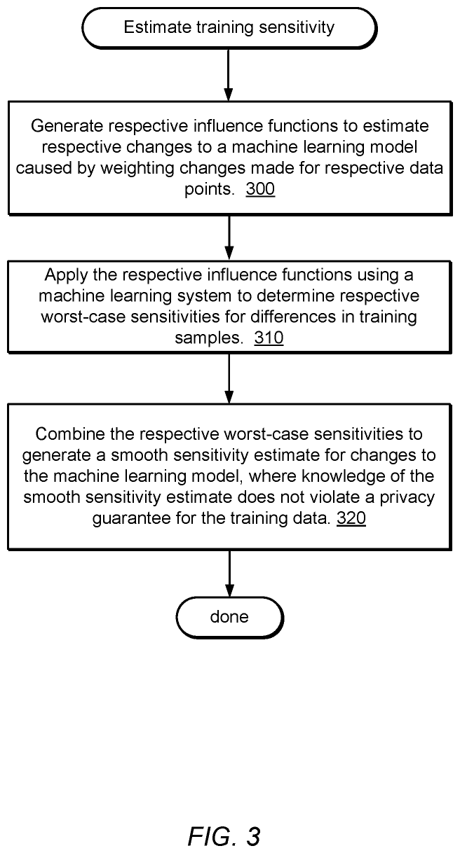

The process may then proceed to step 210 where an estimate of training sensitivity values, such as the sensitivity estimate 145 of FIG. 1, may be generated, in some embodiments. This estimation process is discussed in further detail below in FIG. 3.

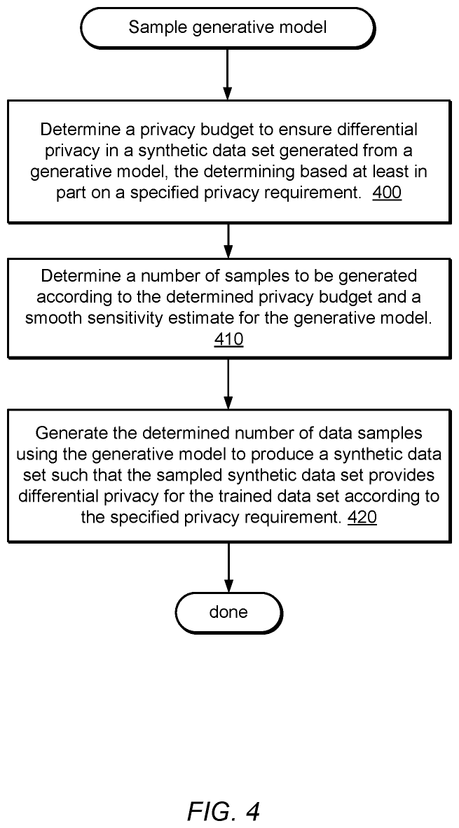

The process may then proceed to step 220 where samples may be selected to generate a synthetic output data set, such as the differentially private sampled synthetic data 160 of FIG. 1, using the generative model, such as the generative model 140 of FIG. 1. This sampling may be performed according to the estimate of training sensitivity values, such as the sensitivity estimate 145 of FIG. 1, and a desired level of differential privacy, such as the privacy requirement 155 of FIG. 1. This sampling process is discussed in further detail below in FIG. 4.

The process may then proceed to step 230 where the output synthetic data set may be generated using the selected samples, producing a data set, such as the differentially private sampled synthetic data 160 of FIG. 1, that provides privacy guarantees for the real data used to train the generative model and does not contain information usable to identify sources of data of the real data set. Therefore, differential privacy of data in the real data set is ensured in the generation of the output synthetic data set.

FIG. 3 is a flowchart illustrating an embodiment for estimating privacy costs for generating samples synthetic data using a generative model. The process begins at step 300 where influence functions, such as influence functions 125 as shown in FIG. 1, may be generated to estimate changes to a machine learning model, such as the generative model 140 of FIG. 1, that would be caused by changes in weighting made to, or addition or deletion of, respective data samples in of a training model, in some embodiments.

The sensitivity of the training process of the generative model may not be known in advance so may be measured empirically. These generated influence functions may be used to measure the impact of individual training points on a learned distribution for the training data set, in some embodiments. This impact is the local sensitivity of the training process on the training data set. Multiple estimates of this sensitivity on separate partitions of data may be used to estimate a smooth sensitivity of the learned distribution in the neighborhood of the data set. This may be used to calculate an approximate (ε, δ)-DP guarantee for sampling a data point from the generator.

As shown in 310, the respective influence functions may be applied using a machine learning system, such as the machine learning system 130 of FIG. 1, to determine respective worst-case sensitivities for differences in training samples, in some embodiments. Influence functions may enable estimates of how the model parameters would change if a particular data point were up-weighted or down-weighted. For example, an estimate of how the learned generative model parameters \hat{θ} would change were one of N data points be removed, x, may be computed as:

$${\hat{θ}}_{- x} - \hat{θ} = ( 1 / N ) {H}_{\hat{θ}}^{- 1} {∇}_{θ} L ( x , \hat{θ} ) ,$$

where ∇_{θ}L(x, \hat{θ}) is the gradient loss function of the generator evaluated on point x and H⁻¹ is the Hessian of loss function on the full data set X. While Hessian computation may be intensive, in practice only a computation of a Hessian vector product may be required in some embodiments. Furthermore, the Hessian-vector product need not be computed for all data records as there is a strong negative correlation between empirical privacy loss and likelihood under the generative model. The goal is to estimate the worst-case privacy loss for the real data, which may be tightly bounded by computing empirical effect sizes on the subset of training examples with the worst fit under the generative model. Computing the influence functions for a small number of training examples is not cost-prohibitive.

The resulting calculation is a first-order approximation of the amount that model parameters would change if a data point were removed from the training set. To see how that influences P (S˜G_{θ}(X)), the chain rule may be applied. Ideally, a worst-case scenario of data points x to add or remove from X may be used to compute the probability difference, and the worst-case S˜G_{θ}(X)). The heuristic S=x may be assumed when calculating the worst-case sensitivity. Given measured sensitivity for each of K data points independently and identically sampled from a distribution over data points in the range of the generator, R, the probability that a data point in that distribution would have an influence larger than the worst-case measured influence is δ=1. If data points may be sampled uniformly from R, the ε calculated from the K data points provides a measured (ε, 1/K)-DP guarantee for data sets adjacent to X. If data points cannot be sampled uniformly from R, the data points may at least be sampled uniformly from X providing an interpretation of a guarantee that is closer to Bayesian Differential Privacy.

As shown in 320, the respective worst-case sensitivity estimates may then be combined to generate a smooth sensitivity estimate for changes to the generative model, in some embodiments. The computed local sensitivity around the data set X cannot be used for a global (ε, δ) guarantee as it may be closely tied to the training data set; thus knowledge of the exact ε may reveal additional information about X and compromising privacy. By leveraging how much ε changes as new data points are added to X, an estimate of the smooth sensitivity εₛ in the region surrounding X may be obtained. Given a fixed privacy budget (ε_{b}, δ>0), N=|ε_{b}/εₛ| samples may be generated from the trained generator, in some embodiments.

FIG. 4 is a flowchart illustrating an embodiment for generating samples of synthetic data using a generative model. The process starts at 400 where a privacy budget may be determined to ensure differential privacy for a synthetic data set generated from a generative model that includes information identifying one or more sources of training data, in some embodiments. This budget may be determined according to a specified privacy requirement, such as the privacy requirement 155 of FIG. 1, associated with or provided with a request for the synthetic data set from a user of a differentially private synthetic data source, such as the differentially private synthetic data source 100 as shown in FIG. 1, in some embodiments. This privacy requirement may be provided in any number of ways, in various embodiments, and the examples above are not intended to be limiting.

As shown in 410, a maximum number of samples may then be determined according privacy budget and the smooth sensitivity estimate, such as the sensitivity estimate 145 of FIG. 1, generated for the generative model, such as the generative model 140 of FIG. 1, as discussed above in FIG. 3, in some embodiments. By including no more than the determined maximum number of samples in the synthetic data set, the data set may not include data from the training data set or information identifying private features of the training data set that may correlate features of the synthetic data to features of the training data is not included in the synthetic data set.

As shown in 420, no more than the determined maximum number of samples may then be generated for the synthetic data set using the generative model, in some embodiments. This synthetic data set may then provide differential privacy for the trained data set in accordance with the specified privacy requirement, in some embodiments. Samples of the synthetic data set 160 may not include data from the training data set or information identifying private features of the training data set that may correlate features of the synthetic data set to features of the training data set, in some embodiments.

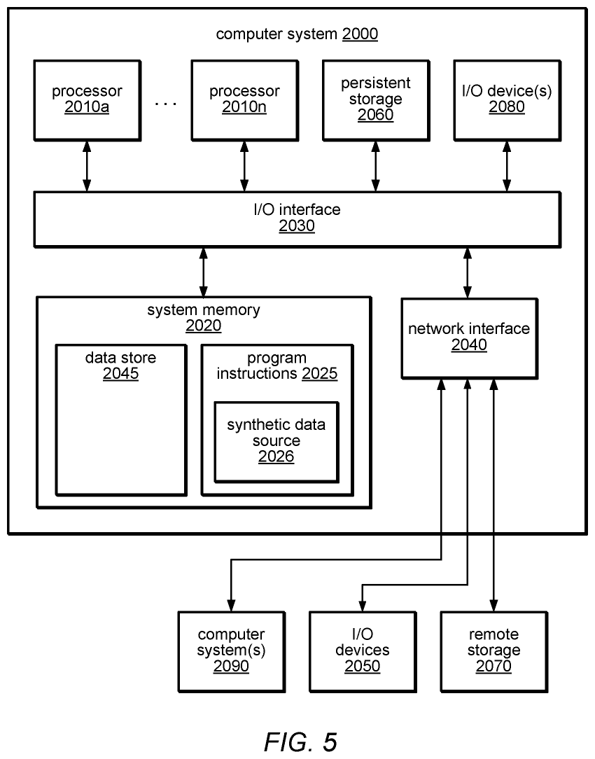

Any of various computer systems may be configured to implement processes associated with a technique for multi-region, multi-primary data store replication as discussed with regard to the various figures above. FIG. 5 is a block diagram illustrating one embodiment of a computer system suitable for implementing some or all of the techniques and systems described herein. In some cases, a host computer system may host multiple virtual instances that implement the servers, request routers, storage services, control systems or client(s). However, the techniques described herein may be executed in any suitable computer environment (e.g., a cloud computing environment, as a network-based service, in an enterprise environment, etc.).

Various ones of the illustrated embodiments may include one or more computer systems 2000 such as that illustrated in FIG. 5 or one or more components of the computer system 2000 that function in a same or similar way as described for the computer system 2000.

In the illustrated embodiment, computer system 2000 includes one or more processors 2010 coupled to a system memory 2020 via an input/output (I/O) interface 2030. Computer system 2000 further includes a network interface 2040 coupled to I/O interface 2030. In some embodiments, computer system 2000 may be illustrative of servers implementing enterprise logic or downloadable applications, while in other embodiments servers may include more, fewer, or different elements than computer system 2000.

Computer system 2000 includes one or more processors 2010 (any of which may include multiple cores, which may be single or multi-threaded) coupled to a system memory 2020 via an input/output (I/O) interface 2030. Computer system 2000 further includes a network interface 2040 coupled to I/O interface 2030. In various embodiments, computer system 2000 may be a uniprocessor system including one processor 2010, or a multiprocessor system including several processors 2010 (e.g., two, four, eight, or another suitable number). Processors 2010 may be any suitable processors capable of executing instructions. For example, in various embodiments, processors 2010 may be general-purpose or embedded processors implementing any of a variety of instruction set architectures (ISAs), such as the x86, PowerPC, SPARC, or MIPS ISAs, or any other suitable ISA. In multiprocessor systems, each of processors 2010 may commonly, but not necessarily, implement the same ISA. The computer system 2000 also includes one or more network communication devices (e.g., network interface 2040) for communicating with other systems and/or components over a communications network (e.g. Internet, LAN, etc.). For example, a client application executing on system 2000 may use network interface 2040 to communicate with a server application executing on a single server or on a cluster of servers that implement one or more of the components of the embodiments described herein. In another example, an instance of a server application executing on computer system 2000 may use network interface 2040 to communicate with other instances of the server application (or another server application) that may be implemented on other computer systems (e.g., computer systems 2090).

System memory 2020 may store instructions and data accessible by processor 2010. In various embodiments, system memory 2020 may be implemented using any suitable memory technology, such as static random-access memory (SRAM), synchronous dynamic RAM (SDRAM), non-volatile/Flash-type memory, or any other type of memory. In the illustrated embodiment, program instructions and data implementing desired functions, such as those methods and techniques as described above providing a differentially private synthetic data source as indicated at 2026, for the downloadable software or provider network are shown stored within system memory 2020 as program instructions 2025. In some embodiments, system memory 2020 may include data store 2045 which may be configured as described herein.

In some embodiments, system memory 2020 may be one embodiment of a computer-accessible medium that stores program instructions and data as described above. However, in other embodiments, program instructions and/or data may be received, sent or stored upon different types of computer-accessible media. Generally speaking, a computer-accessible medium may include computer-readable storage media or memory media such as magnetic or optical media, e.g., disk or DVD/CD-ROM coupled to computer system 2000 via I/O interface 2030. A computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. Further, a computer-accessible medium may include transmission media or signals such as electrical, electromagnetic, or digital signals, conveyed via a communication medium such as a network and/or a wireless link, such as may be implemented via network interface 2040.

In one embodiment, I/O interface 2030 may coordinate I/O traffic between processor 2010, system memory 2020 and any peripheral devices in the system, including through network interface 2040 or other peripheral interfaces. In some embodiments, I/O interface 2030 may perform any necessary protocol, timing or other data transformations to convert data signals from one component (e.g., system memory 2020) into a format suitable for use by another component (e.g., processor 2010). In some embodiments, I/O interface 2030 may include support for devices attached through various types of peripheral buses, such as a variant of the Peripheral Component Interconnect (PCI) bus standard or the Universal Serial Bus (USB) standard, for example. In some embodiments, the function of I/O interface 2030 may be split into two or more separate components, such as a north bridge and a south bridge, for example. Also, in some embodiments, some or all of the functionality of I/O interface 2030, such as an interface to system memory 2020, may be incorporated directly into processor 2010.

Network interface 2040 may allow data to be exchanged between computer system 2000 and other devices attached to a network, such as between a client device and other computer systems, or among hosts, for example. In particular, network interface 2040 may allow communication between computer system 800 and/or various other device 2060 (e.g., I/O devices). Other devices 2060 may include scanning devices, display devices, input devices and/or other communication devices, as described herein. Network interface 2040 may commonly support one or more wireless networking protocols (e.g., Wi-Fi/IEEE 802.7, or another wireless networking standard). However, in various embodiments, network interface 2040 may support communication via any suitable wired or wireless general data networks, such as other types of Ethernet networks, for example. Additionally, network interface 2040 may support communication via telecommunications/telephony networks such as analog voice networks or digital fiber communications networks, via storage area networks such as Fibre Channel SANs, or via any other suitable type of network and/or protocol.

In some embodiments, I/O devices may be relatively simple or “thin” client devices. For example, I/O devices may be implemented as dumb terminals with display, data entry and communications capabilities, but otherwise little computational functionality. However, in some embodiments, I/O devices may be computer systems implemented similarly to computer system 2000, including one or more processors 2010 and various other devices (though in some embodiments, a computer system 2000 implementing an I/O device 2050 may have somewhat different devices, or different classes of devices).

In various embodiments, I/O devices (e.g., scanners or display devices and other communication devices) may include, but are not limited to, one or more of: handheld devices, devices worn by or attached to a person, and devices integrated into or mounted on any mobile or fixed equipment, according to various embodiments. I/O devices may further include, but are not limited to, one or more of: personal computer systems, desktop computers, rack-mounted computers, laptop or notebook computers, workstations, network computers, “dumb” terminals (i.e., computer terminals with little or no integrated processing ability), Personal Digital Assistants (PDAs), mobile phones, or other handheld devices, proprietary devices, printers, or any other devices suitable to communicate with the computer system 2000. In general, an I/O device (e.g., cursor control device, keyboard, or display(s) may be any device that can communicate with elements of computing system 2000.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein.

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Embodiments of decentralized application development and deployment as described herein may be executed on one or more computer systems, which may interact with various other devices. FIG. 5 is a block diagram illustrating an example computer system, according to various embodiments. For example, computer system 2000 may be configured to implement nodes of a compute cluster, a distributed key value data store, and/or a client, in different embodiments. Computer system 2000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of compute node, computing node, or computing device.

In the illustrated embodiment, computer system 2000 also includes one or more persistent storage devices 2060 and/or one or more I/O devices 2080. In various embodiments, persistent storage devices 2060 may correspond to disk drives, tape drives, solid state memory, other mass storage devices, or any other persistent storage device. Computer system 2000 (or a distributed application or operating system operating thereon) may store instructions and/or data in persistent storage devices 2060, as desired, and may retrieve the stored instruction and/or data as needed. For example, in some embodiments, computer system 2000 may be a storage host, and persistent storage 2060 may include the SSDs attached to that server node.

In some embodiments, program instructions 2025 may include instructions executable to implement an operating system (not shown), which may be any of various operating systems, such as UNIX, LINUX, Solaris™, MacOS™, Windows™, etc. Any or all of program instructions 2025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 2000 via I/O interface 2030. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 2040.

Program instructions 2025 may be encoded in a platform native binary, any interpreted language such as Java™ byte-code, or in any other language such as C/C++, the Java™ programming language, etc., or in any combination thereof, to implement various applications such as a differentially private synthetic data source 2026. In various embodiments, applications, operating systems, and/or shared libraries may each be implemented in any of various programming languages or methods. For example, in one embodiment, operating system may be based on the Java™ programming language, while in other embodiments it may be written using the C or C++ programming languages. Similarly, applications may be written using the Java™ programming language, C, C++, or another programming language, according to various embodiments. Moreover, in some embodiments, applications, operating system, and/shared libraries may not be implemented using the same programming language. For example, applications may be C++ based, while shared libraries may be developed using C.

It is noted that any of the distributed system embodiments described herein, or any of their components, may be implemented as one or more network-based services. For example, a compute cluster within a computing service may present computing services and/or other types of services that employ the distributed computing systems described herein to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the network-based service in a manner prescribed by the description of the network-based service's interface. For example, the network-based service may define various operations that other systems may invoke and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the network-based service, using an Internet-based application layer transfer protocol such as Hypertext Transfer Protocol (HTTP).

In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed:

1. A computer-implemented method, comprising:
training a generative model using a real data set, the real data set comprising a plurality of real data records and information identifying one or more sources of the plurality of real data records;
generating a synthetic data set according to the trained generative model, wherein the synthetic data set comprises a plurality of computer-generated data records different from the real data records; and
sampling the generated synthetic data set to ensure differential privacy of the data in the real data set, wherein the sampled synthetic data set excludes the information identifying one or more sources of the real data records.

2. The method of claim 1, further comprising:
training a differentially-private machine learning model according to the sampled synthetic data.

3. The computer-implemented method of claim 1, wherein the synthetic data set comprises information identifying the one or more sources of the plurality of real data records.

4. The computer-implemented method of claim 1, wherein the plurality of real data records are usable to train the generative model to make inferences, and wherein the plurality of computer-generated data records are usable to train another model to make the inferences.

5. The computer-implemented method of claim 1, further comprising:
estimating a training sensitivity for the generative model according to the real data set;
wherein sampling the generated synthetic data set to ensure differential privacy of the data in the real data set is performed according to the estimated training sensitivity.

6. The computer-implemented method of claim 5, wherein the estimating is based at least in part on a Hessian of a loss function of the real data set.

7. The computer-implemented method of claim 5, wherein a number of samples of the sampled generated synthetic data set is determined according to specified amount of differential privacy and the estimated training sensitivity.

8. One or more non-transitory computer-accessible storage media storing program instructions that when executed on or across one or more computing devices cause the one or more computing devices to implement:
generating a differentially private data set, comprising:
training a machine learning model to produce a generative model according to a real data set, the real data set comprising a plurality of real data records and information identifying one or more sources of the real data;
generating synthetic data according to the trained generative model, wherein the synthetic data comprises a plurality of synthetic data records different from the real data records; and
sampling the generated synthetic data to ensure differential privacy of the data in the real data set, wherein the sampled synthetic data excludes the information identifying one or more sources of the real data.

9. The one or more non-transitory computer-accessible storage media of claim 8, further comprising:
training a differentially-private machine learning model according to the sampled synthetic data.

10. The one or more non-transitory computer-accessible storage media of claim 8, wherein the synthetic data set comprises information identifying the one or more sources of the plurality of real data records.

11. The one or more non-transitory computer-accessible storage media of claim 8, wherein the plurality of real data records are usable to train the generative model to make inferences, and wherein the plurality of computer-generated data records are usable to train another model to make the inferences.

12. The one or more non-transitory computer-accessible storage media of claim 8, further comprising:
estimating a training sensitivity for the generative model according to the real data set;
wherein sampling the generated synthetic data set to ensure differential privacy of the data in the real data set is performed according to the estimated training sensitivity.

13. The one or more non-transitory computer-accessible storage media of claim 12, wherein the estimating is based at least in part on a Hessian of a loss function of the real data set.

14. The one or more non-transitory computer-accessible storage media of claim 12, wherein a number of samples of the sampled generated synthetic data set is determined according to specified amount of differential privacy and the estimated training sensitivity.

15. A system, comprising:
one or more processors; and
a memory storing program instructions that when executed by the one or more processors cause the one or more processors to implement a differentially private data set generator, configured to:
train a machine learning model to produce a generative model according to a real data set, the real data set comprising a plurality of real data records and information identifying one or more sources of the real data;
generate synthetic data according to the trained generative model, wherein the synthetic data comprises a plurality of synthetic data records different from the real data records; and
sample the generated synthetic data to ensure differential privacy of the data in the real data set, wherein the sampled synthetic data excludes the information identifying one or more sources of the real data.

16. The system of claim 15, wherein the differentially private data set generator is configured to:
train a differentially-private machine learning model according to the sampled synthetic data.

17. The system of claim 15, wherein the synthetic data set comprises information identifying the one or more sources of the plurality of real data records.

18. The system of claim 15, wherein the plurality of real data records are usable to train the generative model to make inferences, and wherein the plurality of computer-generated data records are usable to train another model to make the inferences.

19. The system of claim 15, wherein the differentially private data set generator is configured to:
estimate a training sensitivity for the generative model according to the real data set;
wherein sampling the generated synthetic data set to ensure differential privacy of the data in the real data set is performed according to the estimated training sensitivity.

20. The system of claim 19, wherein the estimating is based at least in part on a Hessian of a loss function of the real data set.
